(19) United States
(12) Patent Application Publication
(10) Pub. No.: US 2009/0012637 A1
(43) Pub. Date: Jan. 8, 2009

(54) CHORUS POSITION DETECTION DEVICE

(75) Inventors: Tatsuo KOGA, Daito City (JP); Yuji YAMAMOTO, Yawata City (JP); Satoru MATSUMOTO, Izumi City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 12/139,728

(22) Filed: Jun. 16, 2008

(30) Foreign Application Priority Data
Jul. 6, 2007 (JP) JP2007-178222

(51) Int. Cl. G06F 17/00

(52) U.S. Cl. 700/94

(57) ABSTRACT

An audio variation point detector detects whether a variation amount of audio power of the received audio signal is greater than a first threshold, and detects a variation point where the audio power variation is greater than the first threshold. A song detector determines whether the vicinity of the detected variation point is a song, based on a feature amount in a frequency domain of the audio signal in the vicinity of the variation point, and detects a song based on the determination. A chorus position detector detects, as a chorus position candidate, a position where the variation amount of audio power takes a maximum value in the detected song, determines whether a likelihood between a reference feature amount and the feature amount in the frequency domain of the detected chorus position candidate is greater than a second threshold, and detects the chorus position candidate as a chorus position if the likelihood is greater than the second threshold.

### CROSS REFERENCE TO RELATED APPLICATIONS

This application claims priority based on 35 USC 119 from prior Japanese Patent Application No. P2007-178222 filed on Jul. 6, 2007, the entire contents of which are incorporated herein by reference.

### BACKGROUND OF THE INVENTION

1. Field of the Invention

The present invention relates to a chorus position detection device capable of detecting a start position of a chorus part (chorus position) of a song.

2. Description of Related Art

In recent years, audio recording and playback devices capable of recording large amounts of audio files are becoming popular along with the enlargement in the capacity of storage media. Methods for allowing a user to select a song to playback from numerous audio files recorded to an audio recording and playback device include displaying a playback list (title or name of artist), or sequentially playing back the intros of the songs. However, a user cannot select a song to playback with any of these methods, for example, if he/she does not know the title of the song, or has never listened to the intro of the song.

### SUMMARY OF THE INVENTION

An aspect of the invention provides a chorus position detection device for detecting a chorus position of a song in accordance with the feature amount of the song data, that comprises: a power calculator configured to calculate a variation amount of audio power of the song data; and a chorus position detector configured to detect, as the chorus position, a position in which the variation amount of audio power takes a maximum value.

In an embodiment, the device is capable of detecting a chorus position of a song. Moreover, in the case of detecting a chorus position of a song from a song in which a portion thereof is likely to be overlapped with a talk part by a DJ of a radio program or the like, the device is capable of lowering the possibility of wrongly detecting the talk part by the radio DJ as the chorus position.

Another aspect of the invention provides an audio recording and playback device that comprises: an audio signal receiver configured to receive an audio signal; a power calculator configured to calculate a variation amount of audio power of the received audio signal; an audio variation point detector configured to detect whether the calculated variation amount of audio power of the audio signal is greater than a first threshold, and to detect, as a variation point, an audio part in which the audio power variation is greater than the first threshold; a song extraction unit configured to determine whether or not the vicinity of the detected variation point is a song in accordance with a feature amount in a frequency domain of the audio signal in the vicinity of the variation point, and to extract a song on the basis of the determination; and a chorus position detector configured to detect, as a chorus position candidate, a position in which the variation amount of audio power takes a maximum value in the detected song, to determine whether or not a likelihood between a reference feature amount and the feature amount in the frequency domain of the detected chorus position candidate is greater than a second threshold, and to detect the chorus position candidate as a chorus position if the likelihood is greater than the second threshold.

### BRIEF DESCRIPTION OF THE DRAWINGS

FIG. 1 is a block diagram showing a configuration of an audio recording and playback device.

FIG. 2 is a schematic diagram for describing a chorus position detection method.

FIG. 3 is a flowchart showing a procedure of song recording processing.

FIG. 4 is a flowchart showing a detailed procedure of the chorus position detection processing in step S16 of FIG. 3.

FIG. 5 is a flowchart showing a procedure of normal playback processing.

FIG. 6 is a flowchart showing a procedure of chorus part playback processing.

### DETAILED DESCRIPTION OF EMBODIMENT

Next, an embodiment will be described with reference to the drawings. The same or similar numerals are given to the same or similar portions in descriptions of the drawings in the following embodiment.

[1] Configuration of Audio Recording and Playback Device

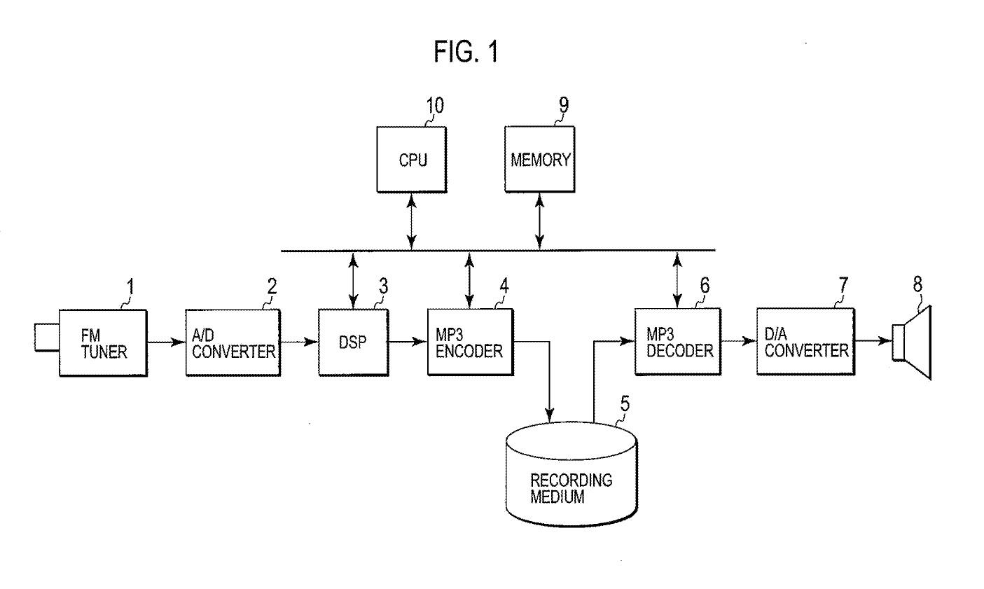

FIG. 1 shows a configuration of an audio recording and playback device. The audio recording and playback device includes FM tuner 1, A/D converter 2, DSP 3, MP3 (MPEG audio layer-3) encoder 4, recording medium 5, MP3 decoder 6, D/A converter 7, speaker 8, memory 9, and CPU 10.

FM tuner 1 outputs an analogue audio signal by demodulating an FM broadcast signal. A/D converter 2 converts the analogue audio signal obtained by FM tuner 1 into a digital audio signal. DSP 3 extracts, from the inputted digital audio signal, a variation amount of audio power and a feature amount in the frequency domain.

MP3 encoder 4 encodes the digital audio signal into compressed MP3 data. Recording medium 5 records the compressed MP3 data obtained by MP3 encoder 4. MP3 decoder 6 decodes the compressed MP3 data back into the digital audio signal. D/A converter 7 converts the digital audio signal obtained by MP3 decoder 6 into an analogue audio signal. Speaker 8 produces audio output of the analogue signal obtained by D/A converter 7. CPU 10 controls the components of the audio recording and playback device.

In this embodiment, the audio recording and playback device includes two recording modes: a normal recording mode and a song recording mode. Specifically, the audio recording and playback device records received audio signals in the normal recording mode, and records only the song parts by extracting the parts from received audio signals in the song recording mode. When recording a song in the song recording mode, the audio recording and playback device detects and records a start position of the chorus part (chorus position) of the song. The audio recording and playback device also includes two playback modes: a normal playback mode and a chorus part playback mode. Specifically, the audio recording and playback device plays back songs selected by a user in the normal playback mode, and sequentially plays back only the chorus parts of the recorded songs in the chorus part playback mode. Upon receipt of a normal playback instruction during the chorus part playback mode, the audio recording and playback device plays back, in the normal mode, from the beginning of the song, the chorus part of which is currently played back.

Hereinafter, descriptions will be given for procedures of song recording processing in the song recording mode, normal playback processing in the normal playback mode, and chorus part playback processing in the chorus part playback mode.

[2] Song Recording Processing

[2-1] Extraction of Song Part

Song recording processing involves extracting and recording only the song part from a received audio signal. A description will be given of a method for extracting a song part. Firstly, the audio recording and playback device detects a timing in which the variation amount of audio power is equal to or more than a predetermined threshold, as a variation point. A square of amplitude of an audio signal, for example, is used as the audio power. Then, the audio recording and playback device detects a feature amount in the frequency domain of the audio signal in the vicinity of the variation point, and then determines, based on the detected feature amount, whether the vicinity of the variation point is a song or a talk part of a radio DJ in a radio program. Mel frequency cepstral coefficients (MFCC) are used, for example, as the feature amount in the frequency domain. More specifically, the audio recording and playback device calculates the likelihood between the detected MFCC and song reference data (MFCC) created in advance, and determines that the vicinity of the variation point is a song when the likelihood exceeds a predetermined threshold a. Otherwise, the audio recording and playback device may calculate an evaluation value by substituting the MFCC in the vicinity of the variation point into an evaluation function created in advance, and then determine, based on the obtained evaluation value, whether the vicinity of the variation point is a song or a talk part.

In the case where the determination that the vicinity of the variation point is a song is continuously made over a predetermined period of time (T1 seconds), the audio recording and playback device determines that the song part starts from a point T1 seconds earlier, and therefore initiates recording of audio signals from the point T1 seconds earlier. Thereafter, if the audio recording and playback device determines that the vicinity of the variation point is not a song, the recording of the audio signals is terminated after the elapse of T1 seconds since the recording position of the audio signals is delayed for T1 seconds at this point. The value T1 is set to be within the range of 30 to 120 seconds, for example.

In this way, the audio recording and playback device separates a song from other audio parts to extract the song part. The extracted song part is handled as a single song, and undergoes the following processing. Other method of extraction of song part is described in U.S. patent application Ser. No. 12/053,647, filed Mar. 24, 2007, which is hereby incorporated by reference.

[2-2] Location of Chorus Part

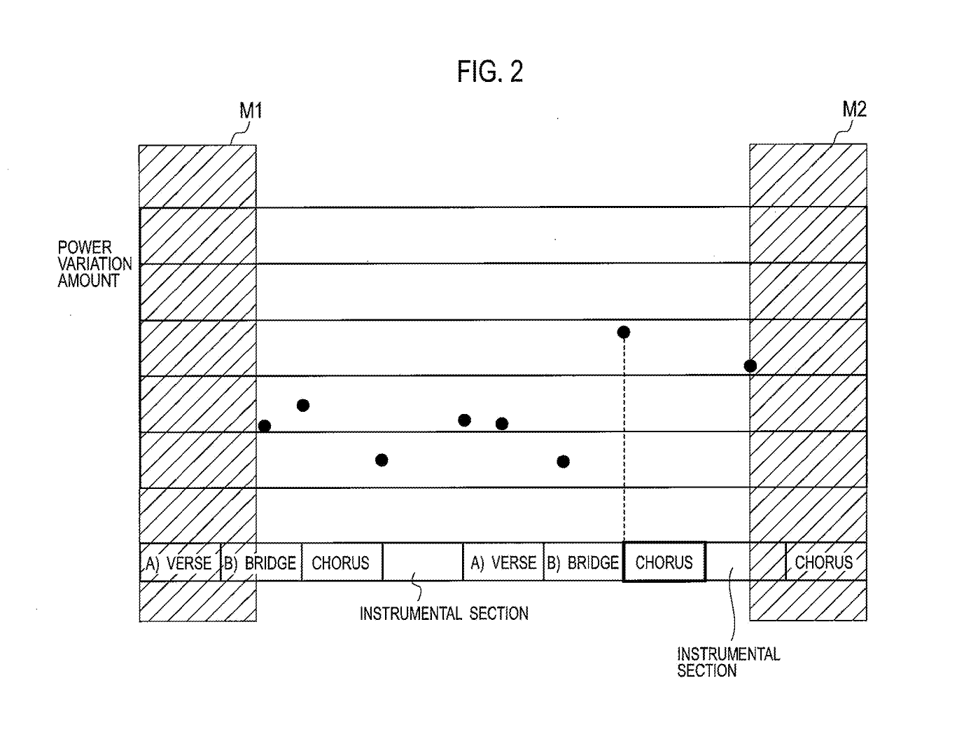

When recording a song, the audio recording and playback device detects a start position of the chorus part (chorus position) of the song. A description will be given of a method for detecting a chorus position. In this embodiment, a “blank” immediately before a chorus part can be detected as a chorus position. Since the variation amount of audio power becomes large in the “blank” immediately before a chorus part as shown in FIG. 2, the “blank” immediately before the chorus part can be detected by detecting a position in which the variation amount of audio power takes a maximum value.

However, in the case of recording a song from a radio program, the variation amount of audio power also becomes large in the talk part such as an introduction of the song by a radio DJ, recorded in an overlapped manner with the song. Accordingly, there is a possibility that the talk part by the radio DJ is wrongly detected as the “blank” immediately before the chorus part.

Thus, parts excluding the portions in which the talk part by the radio DJ is likely to overlap the song are set to be the target range for detecting the chorus part. Specifically, the excluded portions are the initial part of the song (shaded area denoted by M1 in FIG. 2) and the end part of the song (shaded area denoted by M2 in FIG. 2). Further, the audio recording and playback device determines, in accordance with the feature amount of the frequency of the audio signal in the vicinity of a chorus position candidate detected based on the variation amount of audio power, whether the vicinity of the chorus position candidate is likely to be a song. If the possibility is high, the audio recording and playback device determines that the chorus position candidate is the chorus part. If the possibility is low, the audio recording and playback device detects a position in which the variation amount of audio power takes the next largest value as the chorus position candidate, and carries out the same processing described above until a chorus position candidate is determined to be a chorus position.

A more specific description will be given of the method for detecting the chorus position. Firstly, the detection target range is determined. That is, the audio recording and playback device sets, as a first position, a position after the elapse of T2 seconds from the start position of the song recorded to the recording medium, and sets, as a second position, a position T3 seconds before the end position of the song. Then, the audio recording and playback device determines the range from the first position to the second position as the detection target range. Each of the values T2 and T3 is set to take a value within the range of 15 to 30 seconds, for example. Next, the audio recording and playback device detects, from within the detection target range, a position in which the variation amount of audio power takes the maximum value, as the chorus position candidate. The audio recording and playback device then determines whether the vicinity of the detected chorus position candidate is highly likely or less likely to be a song, on the basis of the feature amount in the frequency domain of the audio signal in the vicinity of the chorus position candidate. The MFCC is used as the feature amount in the frequency domain, for example. More specifically, the audio recording and playback device calculates the likelihood between the MFCC in the vicinity of the chorus position candidate and song reference data (MFCC) created in advance, and determines whether the calculated likelihood exceeds a predetermined threshold β. If the likelihood is greater than the predetermined threshold β, the audio recording and playback device determines that the chorus position candidate is the chorus part. If the likelihood is smaller than the predetermined threshold β, the audio recording and playback device detects, within the detection target range, a position in which the variation amount of audio power takes the next largest value as the chorus position candidate, and carries out the same processing described above until a chorus position candidate is determined to be a chorus position.

[2-3] Song Recording Processing

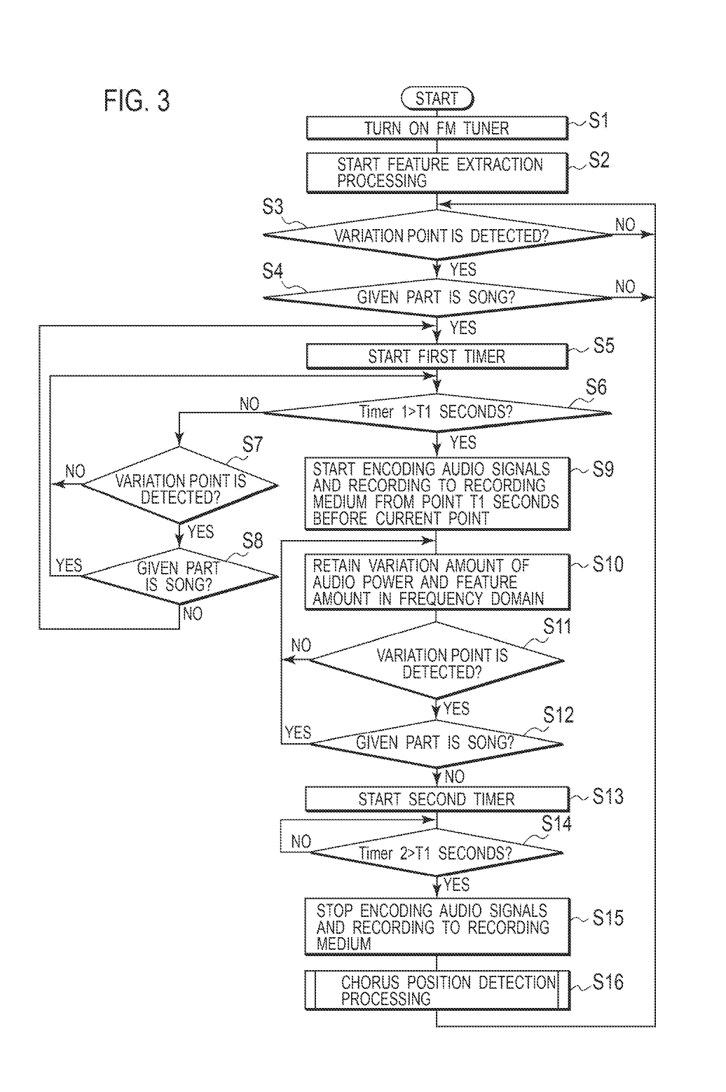

Hereinbelow, a description will be given of the song recording processing in reference to FIG. 3. Firstly, FM tuner 1 is turned on to receive an audio signal (step S1). Then, DSP 3 starts feature extraction processing (step S2). Here, DSP 3 calculates the variation amount of audio power and the feature amount in the frequency domain from an inputted digital audio signal, and forwards the two to CPU 10. A square of the amplitude of the audio signal is used as the audio power, for example. Mel frequency cepstral coefficients (MFCC) are used as the feature amount in the frequency domain, for example.

CPU 10 determines whether or not the position is a variation point, based on the received variation amount of audio power (step S3). If the position is not a variation point, the processing returns to step S3. If CPU 10 determines that the position is a variation point, that is, if the variation amount of audio power exceeds a predetermined threshold (YES in step S3), CPU 10 determines whether or not the vicinity of the variation point is a song, based on the feature amount in the frequency domain (MFCC in this example) of the audio signal in the vicinity of the variation point (step S4). If the vicinity of the variation point is not a song, the processing returns to step S3.

In the case where CPU 10 determines that the vicinity of the variation point is a song in step S4, a first timer is started (step S5). Then, CPU 10 determines whether or not a period (Timer 1) timed by the first timer exceeds T1 seconds (step S6). If the period (Timer 1) timed by the first timer is equal to or less than T1 seconds, CPU 10 determines whether or not the position is a variation point, based on the variation amount of audio power (step S7). If the position is not a variation point, the processing returns to step S6. If the position is determined to be a variation point in the step S7, CPU 10 determines whether or not the vicinity of the variation point is a song, based on the feature amount of the frequency domain (MFCC in this example) of the audio signal in the vicinity of the variation point (step S8). If the vicinity of the variation point is determined to be a song, the processing returns to step S6.

If CPU 10 determines that the vicinity of the variation point is not a song in the step S8, the processing returns to step S5, and the timing by the first timer is started. In this case, the timing by the first timer is restarted.

If the period (Timer 1) timed by the first timer is determined to exceed T1 seconds in the step S6, CPU 10 determines that the song starts from a point T1 seconds earlier, and initiates encoding of audio signals and recording to recording medium 5 from the point T1 seconds earlier (step S9).

Next, in order to carry out the later-described chorus position detection processing, CPU 10 retains the variation amount of audio power and the feature amount in the frequency domain (MFCC in this example) (step S10). CPU 10 also determines whether or not the position is a variation point, based on the variation amount of audio power (step S11). If the position is not a variation point, the processing returns to step S10. If the position is determined to be a variation point, that is, if the variation amount of audio power exceeds a predetermined threshold (YES in step S11), CPU 10 determines whether or not the vicinity of the variation point is a song, based on the feature amount in the frequency domain (MFCC in this example) of the audio signal in the vicinity of the variation point (step S12). If CPU 10 determines that the vicinity of the variation point is a song, the processing returns to step S10.

If CPU 10 determines that the vicinity of the variation point is not a song in the step S12, a second timer is started (step S13). Then, if a period (Timer 2) timed by the second timer reaches T1 seconds (step S14), CPU 10 stops the encoding of audio signals and the recording to recording medium 5 (step S15).

Thereafter, the chorus position detection processing is performed on the recorded song (step S16). Then, the processing returns to step S3.

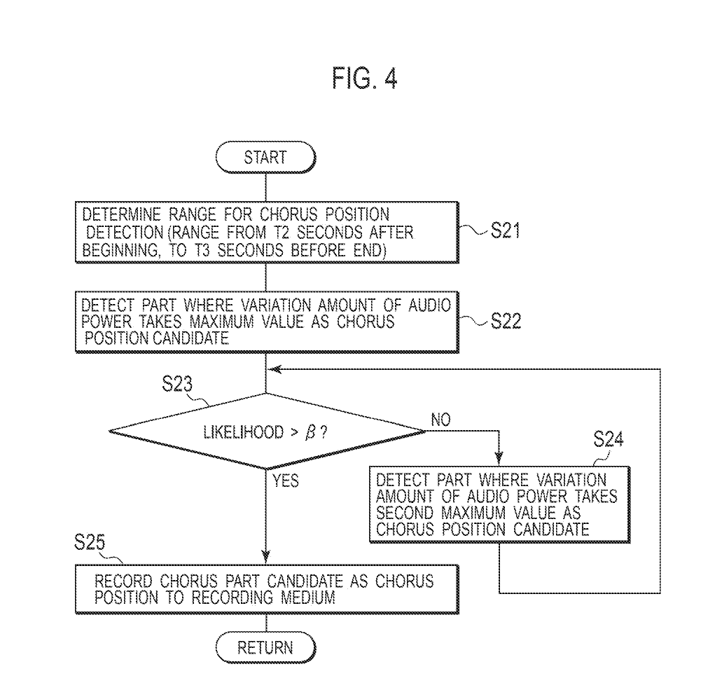

FIG. 4 shows a detailed procedure of the chorus position detection processing of step S16 in FIG. 3. Firstly, CPU 10 determines the chorus position determination range (step S21). To be specific, CPU 10 sets, as a first position, a position after the elapse of T2 seconds from the start position of the song, and sets, as a second position, a position T3 seconds before the end position of the song. Then, and CPU 10 determines the range from the first position to the second positions as the chorus position detection range.

Next, CPU 10 detects, within the chorus position detection range, a position in which the variation amount of audio power takes the maximum value, as a chorus position candidate (step S22). Then, CPU 10 calculates the likelihood between the feature amount in the frequency domain (MFCC in this example) of the audio signal in the vicinity of the chorus position candidate and song reference data (MFCC) created in advance, and determines whether the likelihood exceeds a predetermined threshold β (step S23).

If the likelihood is equal to or smaller than the predetermined threshold β in the step S23, CPU 10 detects a position in which the variation amount of audio power takes the next largest value as a new chorus position candidate (step S24), and the processing returns to step S23.

If the likelihood is determined to be greater than the predetermined threshold β in the step S23, CPU 10 records the current chorus position candidate as the chorus position of the recorded song to recording medium 5 (step S25). Thereafter, the processing returns to step S3 in FIG. 3.

[3] Normal Playback Processing

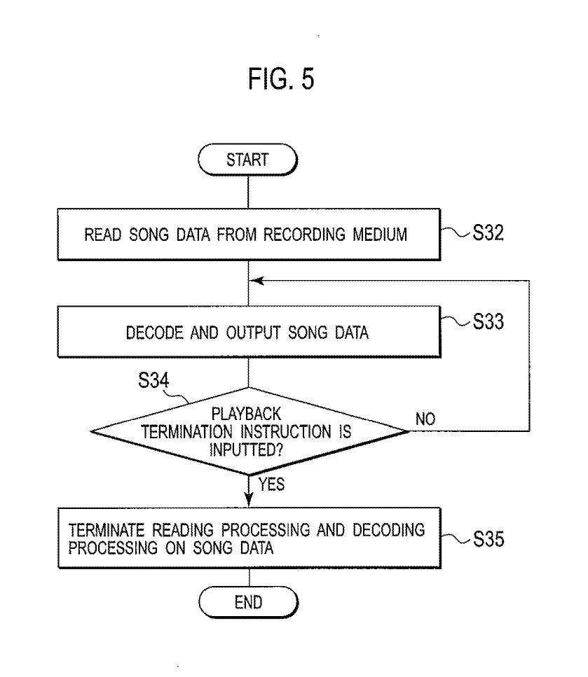

FIG. 5 shows a procedure of normal playback processing. Upon receipt of a normal playback instruction after a selection of a song to be played back is made by a user, CPU 10 reads the selected song data from recording medium 5 (step S32). CPU 10 then causes the song data read from recording medium 5 to be decoded by MP3 decoder 6, and thereby to be outputted from speaker 8 (step S33). Thus, the song selected by the user is played back.

During playback of song data, CPU 10 monitors whether or not a playback stop instruction is inputted. Upon receipt of a playback stop instruction during playback of a song (step S34), CPU 10 stops the processing for reading song data from recording medium 5 and the decoding processing by MP3 decoder 6 (step S35).

[4] Chorus Part Playback Processing

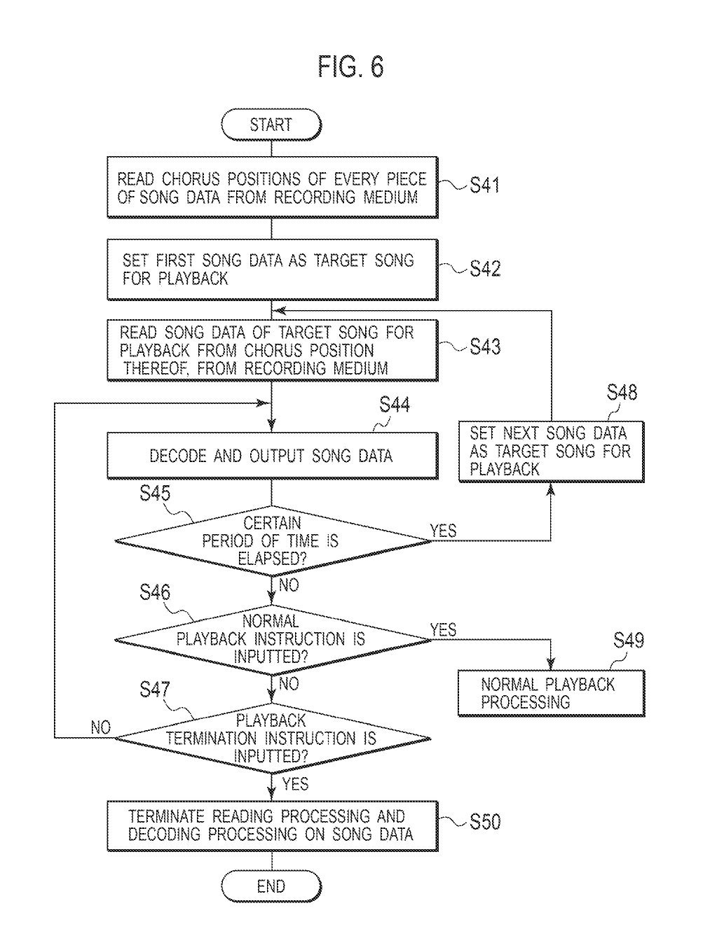

FIG. 6 shows a procedure of the chorus part playback processing. Upon receipt of a chorus part playback instruction, CPU 10 reads the chorus part of every song data from recording medium 5 (step S41), and sets the first song data as the playback target song (step S42). CPU 10 then reads, from recording medium 5, the song data of the playback target song from the chorus position thereof (step S43). Thereafter, CPU 10 causes MP3 decoder 6 to decode the song data read from recording medium 5, and thereby to be outputted from speaker 8 (step S44). Thus, the chorus part of the playback target song is played back. CPU 10 then determines whether a predetermined time period has elapsed after initiation of the playback of the chorus part of the playback target song (step S45).

If the predetermined time period has not elapsed, CPU 10 determines whether or not a normal playback instruction is inputted (step S46). If the normal playback instruction is not inputted, CPU 10 further determines whether or not a playback stop instruction is inputted (step S47). If the playback stop instruction is not inputted, the processing returns to step S44.

If CPU 10 determines in the step S45 that a predetermined time period has elapsed after initiation of playback of the chorus part of the playback target song, the next song data is set to be the playback target song, and then the processing returns to step S43. Thus, playback of the chorus part of the next song data is initiated.

If CPU 10 determines in the step S46 that the normal playback instruction is inputted, normal playback processing is performed on the current playback target song (step S49). In other words, the current playback target song is played back from the beginning thereof.

If CPU 10 determines in the step S47 that the playback stop instruction is inputted, the processing for reading song data from recording medium 5 and the decoding processing by MP3 decoder 6 are terminated (step S50).

The chorus part in a song is the peak part of the song, and thus has the largest impact on a user. Accordingly, if the chorus parts alone of songs can be sequentially played back when causing a user to select a song to be played back from various music files recorded to an audio recording and playback device, the user can more easily select the song to be played back.

Although MP3 is employed as the compression scheme of song data in the above embodiment, schemes other than MP3 may be employed. Additionally, although an example has been described of recording a song from FM radio broadcast, the present invention can also be applied to the case of recording a song distributed on the Internet, or the like.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A chorus position detection device for detecting a chorus position of a song based on the feature amount of the song data, the device comprising
a power calculator configured to calculate a variation amount of audio power of the song data, and
a chorus position detector configured to detect, as the chorus position, a position in which the variation amount of audio power takes a maximum value.

2. The device of claim 1, wherein the chorus position detector comprises:
a unit configured to calculate a feature amount in a frequency domain of the song data;
a unit configured to detect, as a chorus position candidate, a position in which the variation amount of audio power takes a maximum value;
a unit configured to determine whether the vicinity of the detected chorus position candidate is highly likely or less likely to be a song, on the basis of the feature amount in the frequency domain of the song data in the vicinity of the chorus position candidate;
a unit configured to determine that the chorus position candidate is a chorus position if the vicinity of the chorus position candidate is highly likely to be a song; and
a unit configured to detect, if the vicinity of the chorus position candidate is less likely to be a song, a position in which the variation amount of audio power takes the next largest value as a chorus position candidate, and to perform the same processing on the detected chorus position candidate.

3. The device of claim 1, wherein the chorus position detector is configured to define a range of the song data as a detection range and to detect a chorus position within the detection range, the detection range being a range excluding at least any one of a part having a certain length from the beginning of the song data and a part having a certain length to the end of the song data.

4. An audio recording and playback device comprising:
an audio signal receiver configured to receive an audio signal;
a power calculator configured to calculate a variation amount of audio power of the received audio signal;
an audio variation point detector configured to detect whether the calculated variation amount of audio power of the audio signal is greater than a first threshold, and to detect, as a variation point, an audio part in which the variation amount of audio power is greater than the first threshold;
a song extraction unit configured to determine whether the vicinity of the detected variation point is a song, based on a feature amount in a frequency domain of the audio signal in the vicinity of the variation point, and to extract a song based on the determination; and
a chorus position detector configured to detect, as a chorus position candidate, a position in which the variation amount of audio power takes a maximum value in the detected song, to determine whether a likelihood between a reference feature amount and the feature amount in the frequency domain of the detected chorus position candidate is greater than a second threshold, and to detect the chorus position candidate as a chorus position if the likelihood is greater than the second threshold.

5. The device of claim 4, wherein
the chorus position detector is configured to define a detection target position range in the detected song by setting a position from the beginning of the song after the elapse of a certain time period as a first position and setting a position a certain time period earlier than the end of the song as a second position, and then to detect a chorus position candidate within the detection target position range from the first position to the second position.

6. The device of claim 4, wherein
the chorus position detector is configured to detect, as a chorus position candidate, a position in which the variation amount of audio power takes a maximum value in the detected song, to determine whether or not a likelihood between a reference feature amount and a feature amount in a frequency domain of the detected chorus position candidate is or greater than a second threshold, and to detect, if the likelihood is greater than the second threshold, the chorus position candidate as a chorus position, while detecting, if the likelihood is equal to or smaller than the second threshold, a position in which the variation amount of audio power takes the next largest value as another chorus position candidate, to thus determine whether a likelihood between the reference feature amount and a feature amount in a frequency domain of the detected chorus position candidate is greater than the second threshold.
